(19) United States
(12) Patent Application Publication
(10) Pub. No.: US 2012/0179751 A1
(43) Pub. Date: Jul. 12, 2012

(54) COMPUTER SYSTEM AND METHOD FOR SENTIMENT-BASED RECOMMENDATIONS OF DISCUSSION TOPICS IN SOCIAL MEDIA

(75) Inventors: Hyung-il Ahn, San Jose, CA (US); Casey Dugan, Winchester, MA (US); Werner Geyer, Newton, MA (US); David R. Millen, Boxford, MA (US)

(73) Assignee: INTERNATIONAL BUSINESS MACHINES CORPORATION, Armonk, NY (US)

(21) Appl. No.: 13/080,939

(22) Filed: Apr. 6, 2011

Related U.S. Application Data
(60) Provisional application No. 61/430,516, filed on Jan. 6, 2011.

(51) Int. Cl. G06F 15/16

(52) U.S. Cl. 709/204

(57) ABSTRACT

An online discussion recommendation system ranks and presents to users of a social media site discussions of interest preferably calculated through interest-matching. The discussion has many online posts. The system and method determine which post to present to the user as a sample snippet from such discussion using sentiment analysis. The sentiment of the snippet may be most polarized, sentiment matching the user's current mood, typical user sentiment, or others.

### CROSS-REFERENCE TO RELATED APPLICATION(S)

This application claims the benefit of U.S. Provisional Application No. 61/430,516 filed Jan. 6, 2011 and entitled “System for Sentiment Based Recommendations of Discussion Topics in Social Media”.

The foregoing patent application is incorporated by reference in its entirety.

### BACKGROUND

Popular social media sites are attracting millions of users who contribute and consume content. A major activity on those sites besides uploading content (such as photos, videos, bookmarks etc.) is to talk about the shared content. Those discussions are typically represented as comments from different users on the content pages of the site. Sometimes, as in the case of discussion forums, only a topic but no content is associated with the discussion.

Given the number of discussions on those sites, finding interesting and relevant discussions to follow is a challenge. Recommendation systems can help users identify discussions that match their interest, for example, by applying data mining techniques that compare a user profile with discussion topics and comments. Discussion recommendations are ranked and then displayed in a user interface that renders, for each recommended discussion, the discussion topic and optionally a summary or sample comments from the discussion. As referred to herein, a “snippet” is the combination of discussion topic and sample comments (this is very similar to the way search results are presented in Google, for example). For objects such as videos or photos, the discussion topic could be considered the social media object's title.

Existing solutions focus on displaying the most relevant keywords in the snippet in order to attract users to click-through and go to the discussion. However, matching keywords are not the only, and not necessarily the most effective, way to attract users to click on the recommended discussion.

Another approach is to show the topic and most recent comments. This is often done in forums. For discussions taking place around content shared on social media sites, it is unclear which of any of hundreds of possible comments left on a given discussion or item should be included in the snippet.

### BRIEF SUMMARY

The present invention addresses the above problems, shortcomings and disadvantages of prior art. The present invention provides a discussion recommendation system and method that leverages sentiment information of discussion topics and comments when generating and presenting snippets to users.

The present invention improves the click-through likelihood of users by selecting sample comments from matching discussions that reflect either positive or negative sentiment and, optionally, matches a users sentiment preferences or mood. After creating a rank ordered list of matching discussions (discussion recommendations), the system analyzes the sentiment of each comment in each discussion and assigns a positive or negative sentiment score. Or, optionally the system assigns a score for other sentiment categories (e.g. anger, happiness etc.). The system then creates a respective snippet for each recommendation by selecting one or more sample comments with a high sentiment score. Optionally, the system can also match the sentiment chosen for the snippet with the sentiment profile of a user. For example, if users in the past preferred to read positive discussions, then the system selects positive sentiment scoring comments for the snippet.

A preferred embodiment provides a computer implemented method and system of recommending online discussions on social media sites. The method and system include:
in a computer:
   determining at least one discussion of plural online discussions to recommend to a given user, the one discussion having online posts by other users;
   using a sentiment analysis, determining one or more of the online posts of the one discussion to present as a sample snippet of the one discussion, such that sentiment of the snippet improves likelihood of click-through by the given user; and
   displaying to the given user the sample snippet in a recommendation of the one discussion.

In accordance with one aspect of the present invention, the online discussions take place around online shared content, such as in a social media site. The recommendation of the one discussion is displayed on the social media site.

In embodiments, the step of determining the one discussion includes interest matching.

In embodiments, the sentiment analysis determines the one or more of the online posts that reflect either positive or negative sentiment. The sentiment of the snippet may match a sentiment profile of the given user, or the sentiment of the snippet may match current detected mood of the given user.

Further the sentiment analysis can optionally assign a score for different emotion categories. These emotion categories may include, but are not limited to, any combination of joy, sadness, anger and fear.

### BRIEF DESCRIPTION OF THE SEVERAL VIEWS OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of a computer network in which embodiments of the present invention are deployed.

FIG. 2 is a block diagram of a computer node in the computer network of FIG. 1.

FIG. 3 is a flow diagram of a sentiment analysis in one embodiment following a hybrid approach.

### DETAILED DESCRIPTION

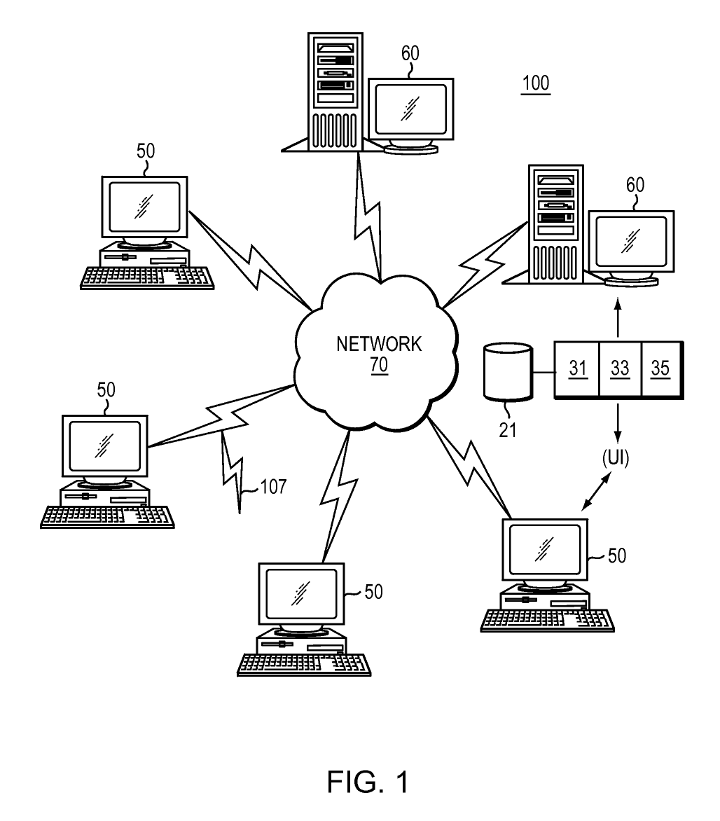

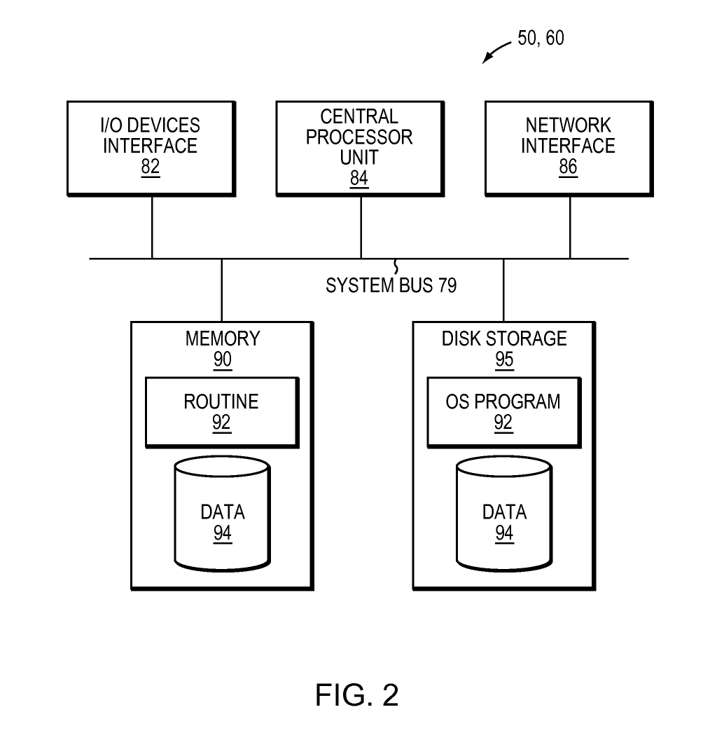

Various example systems 100 embodying the present invention are described below with reference to FIGS. 1 and 2.

FIG. 1 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

FIG. 2 is a diagram of the internal structure of a computer (e.g., client processor/device 50 or server computers 60) in the computer system of FIG. 1. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 1). Memory 90 provides volatile storage for computer software instructions 92 and data 94 used to implement an embodiment system 100 of the present invention (e.g., topic matching member 31, sentiment analysis unit 33, a recommender 35 and supporting code detailed below). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

Embodiments of the invention provide systems 100 having: (a) a Personalized Topic-Matching Member 31, (b) a Sentiment Analysis Unit 33, and (c) a Recommendation Process/Processor 35. The Personalized Topic-Matching Member 31 carries out Steps 1-3 below. The Sentiment Analysis Unit 33 is represented by Step 4 below. And the Recommendation process/recommender 35 is represented by Step 5 below.

The purpose of the personalized topic matching of member 31 is to discover a set of discussions that each user would be interested in.

Step 1: System 100, namely topic matching member 31 creates a discussion/topic index that contains all the keywords used in each discussion. To accomplish this, given a source of discussions (say a subject social media site), for each discussion, member 31 extracts a bag-of-words from the discussion title, tags, description and all comments. Then, member 31 removes stopwords using a customized stop word list that contains common English words, and stems the remaining words using a stemmer (e.g., Porter Stemmer). All remaining word stems are used as keywords to construct a word vector that describes the discussion.

Note that a word vector is composed of elements each of which corresponds to a keyword (or word stem). In one embodiment, the value of each element in the word vector could be computed using a TF-IDF (term-frequency inverse-document-frequency) score associated with the keyword. All keywords and corresponding TF-IDF scores for each discussion are stored in a database 21.

Step 2: Next, Personalized Topic-Matching member 31 creates a user index that contains all the keywords describing a user's interest. For each user, topic matching member 31 extracts a bag-of-words from multiple data sources (e.g. from online profiles on Facebook or other sites) that describe the user. Then, member 31 removes stopwords using a customized stop word list that contains common English words, and stems the remaining words using a stemmer (e.g., Porter Stemmer). All remaining word stems are used as keywords to construct a word vector that describes the user.

Note that a word vector is composed of elements each of which corresponds to a keyword (or word stem). In one embodiment, the value of each element in the word vector is computed using a TF-IDF (term-frequency inverse-document-frequency) score associated with the keyword. All keywords and corresponding TF-IDF scores for each user are stored in the database 21.

Step 3: Member 31 computes matches between users and discussions using a similarity metric (e.g. cosine similarity, keyword overlap etc.) and ranks matched user-discussion pairs according to the match score. For each possible user and discussion pair, member 31 computes a match score between the user word vector and the discussion word vector. The match score can be computed in several ways, such as the cosine similarity (i.e., the normalized inner product value between the two word vectors) or the sum of TF-IDF scores on the discussion word vector for keywords overlapped in the two word vectors. Then, per user, member 31 filters or otherwise finds all the discussions with a match score greater than a pre-specified threshold value, ranks and stores these discussions in the database 21 as future recommendations.

Step 4: Given the recommended discussions above, for each discussion topic and comment pair (T,C), Sentiment Analysis unit 33 computes sentiment scores using a hybrid sentiment analysis approach (detailed below) building on existing dictionary- and machine learning-based approaches. Sentiment Analysis unit 33 classifies each (T,C) pair into an emotion class (e.g., positive, negative, or neutral). Note that this invention is not limited to positive/negative/neutral classification.

There are several approaches for sentiment analysis, such as a dictionary-based approach, a machine learning-based approach, and a hybrid approach. Examples include:

Kerstin Denecke: Using SentiWordNet for multilingual sentiment analysis. ICDE Workshops 2008: pages 507-512;

Bo Pang, Lillian Lee, and Shivakumar Vaithyanathan. (2002). Thumbs up? Sentiment Classification using Machine Learning Techniques. EMNLP Proceedings. pages 79-86;

Keke Cai, W. Scott Spangler, Ying Chen, Li Zhang: Leveraging Sentiment Analysis for Topic Detection. Web Intelligence 2008: pages 265-271;

Vikas Sindhwani, Prem Melville: Document-Word Co-regularization for Semi-supervised Sentiment Analysis. ICDM 2008: pages 1025-1030;

J. W. Pennebaker, M E Francis, R J Booth. (2001). Linguistic Inquiry and Word Count (LIWC): LIWC2001. Mahwah: Lawrence Erlbaum Associates.

Alastair J. Gill, Darren Gergle, Robert M. French, Jon Oberlander: Emotion rating from short blog texts. CHI 2008: pages 1121-1124.

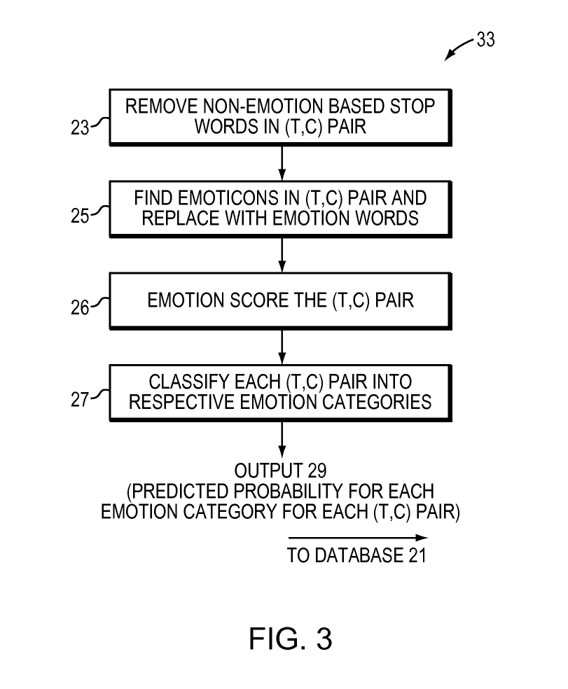

In a preferred embodiment, system 100/sentiment analysis unit 33 apply the following, hybrid analysis algorithm as outlined in flow diagram FIG. 3. First, the Sentiment Analysis (unit 33) removes 23 all the non-emotion based stopwords found in a subject text (e.g., a (T,C) pair).

Next, the subject analysis (unit 33) finds 25 all emoticons in the subject text using emoticon dictionaries, and replaces the emoticons (e.g., positive, negative, joy, sadness, anger, fear) with appropriate emotion words. For example, the emoticons such as “:-)”, “:)”, “:o)” are each replaced with the term “nice”. In this way the unit 33 analysis supplements an existing affective dictionary (e.g., LIWC, SentiWordNet), which does not include any emoticons. In other embodiments, analysis step 25 includes emotion based abbreviations (e.g., LOL, WOW, etc.) along with emoticons.

Continuing at 26 in FIG. 3, the sentiment analysis by unit 33 finds all emotion-related words in the subject (T,C) pair and determines the emotion scores (e.g., positive, negative, joy, sadness, anger scores) corresponding to each word using an affective dictionary (e.g. SentiWordNet, LIWC, WordNetAffect, etc.). Some dictionary-based tools (LIWC) automatically compute summary scores for each emotion category, others require manual computation of the summary scores for each emotion category, e.g. summing up all term-based emotion scores of that category. For example, positive/negative overall scores reflect how positive/how negative the (T,C) pair is. The overall emotion scores for each category for each (T,C) are stored in database 21.

Next, the analysis by unit 33 uses a machine learning-based approach to build a classifier that classifies 27 each (T,C) pair into different emotion categories (e.g., positive/neutral/negative, or others). The classifier is trained with emotion category information collected from a set of sample (T, C) pairs labelled by humans. In other words, analysis unit 31 (at element 27) uses a state-of-the-art machine-learning technique (e.g., support vector machines, neural networks, naive bayes, logistic regression) to learn a classifier that statistically best maps the overall emotion scores for sample (T,C) pairs to the human-labeled emotion categories of the training set. The preferred embodiment uses a cross-validation criterion to find such a classifier. As a result, analysis unit 33 obtains the predicted probability 29 for each emotion category for each (T,C) pair. Analysis unit 33 stores these predicted probabilities 29 for each (T,C) pair in the database 21.

Step 5: For each user u, recommendation process (recommender) 35 chooses (T,C) pairs as recommended snippets where T was among the matched discussions computed for user u in Step 3 above.

Recommender 35 may employ the following strategies for selecting (T,C) pairs:

a) Choose (T,C) pairs with high sentiment score (positive/negative, or other emotion categories), i.e. reorder the list of recommended snippets (T,C) by sentiment score;

b) Create an emotion profile for a user u, for example, by analyzing keywords from the user profile, comments contributed to discussions, discussions read, etc. Find (T,C) pairs that match best the users emotion profile, for example, by using similarity metrics such as cosine-similarity, etc.

c) Choose (T,C) pairs based on a user's current emotional state, for example by monitoring user's input (e.g. search queries, instant messages, comments, emails, etc.), and preferences (e.g. user profile);

d) Infer user preferences based on previous (T,C) pairs recommended (for example, clicked through by the user) and adjust accordingly by the selection criteria for (T,C) pairs.

On output to the user in a user interface (e.g., in th user interface of the subject social media site), recommendation process 35/system 100 provides a rank ordered list of recommended discussions, and displays each with a snippet having a high sentiment score (or a matching sentiment to the sentiment preferences or mood of the user). In this way, the present invention improves the click-through likelihood of users on system generated recommendations of discussions (discussion topics) in social media.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While this invention has been particularly shown and described with references to example embodiments thereof, it will be understood by those skilled in the art that various changes in form and details may be made therein without departing from the scope of the invention encompassed by the appended claims.

What is claimed is:

1. A computer based method of recommending an online discussion comprising:
in a computer:
determining at least one discussion of plural online discussions to recommend to a given user, the one discussion having online posts by other users;
using a sentiment analysis, determining one or more of the online posts of the one discussion to present as a sample snippet of the one discussion, such that sentiment of the snippet improves likelihood of click-through by the given user; and
displaying to the given user the sample snippet in a recommendation of the one discussion.

2. A method as claimed in claim 1 wherein the recommendation of the one discussion is displayed on a social media site.

3. A method as claimed in claim 1 wherein the plural online discussions take place around online shared content.

4. A method as claimed in claim 1 wherein the step of determining the one discussion includes interest matching.

5. A method as claimed in claim 1 wherein the sentiment of the snippet matches a sentiment profile of the given user.

6. A method as claimed in claim 1 wherein the sentiment of the snippet matches current detected mood of the given user.

7. A method as claimed in claim 1 wherein the sentiment analysis determines the one or more of the online posts that reflect either positive or negative sentiment.

8. A method as claimed in claim 1 wherein the sentiment analysis assigns a score for different emotion categories.

9. A method as claimed in claim 8 wherein the emotion categories include any combination of joy, sadness, anger and fear.

10. A computer system recommending an online discussion, comprising:
a processor member configured to determine at least one discussion of plural online discussions to recommend to a given user, the one discussion having online posts by other users:
a sentiment analysis unit executed by a computer and based on sentiment determining one or more of the online posts of the one discussion to present as a sample snippet of the one discussion, such that sentiment of the snippet improves likelihood of click-through by the given user; and
a recommendation processor presenting in an output display to the given user the sample snippet in a recommendation of the one discussion.

11. A computer system as claimed in claim 10 wherein the recommendation of the one discussion is displayed on a social media site.

12. A computer system as claimed in claim 10 wherein the plural online discussions take place around an online shared content.

13. A computer system as claimed in claim 10 wherein the processor member determines the one discussion using interest matching.

14. A computer system as claimed in claim 10 wherein the sentiment of the snippet matches a sentiment profile of the given user.

15. A computer system as claimed in claim 10 wherein the sentiment of the snippet matches current detected mood of the given user.

16. A computer system as claimed in claim 10 wherein the sentiment analysis unit determines the one or more of the online posts that reflect either positive or negative sentiment.

17. A computer system as claimed in claim 10 wherein the sentiment analysis unit assigns a score for different emotion categories.

18. A computer system as claimed in claim 17 wherein the emotion categories include any combination of joy, sadness, anger and fear.

19. A computer program product for recommending online discussions, the computer program product comprising:
a computer readable storage medium having computer readable program code embodied therewith, the computer readable program code comprising:
a computer readable program code configured to determine at least one discussion from plural online discussions to recommend to a given user, the one discussion having online posts by other users;
a second computer readable program code configured to use a sentiment analysis and determine one or more of the online posts of the one discussion to present as a sample snippet of the one discussion, such that sentiment of the snippet improves likelihood of click-through by the given users; and
a third computer readable program code configured to display to the given user the sample snippet in a recommendation of the one discussion.

20. A computer program product as claimed in claim 19 wherein the online discussions take place around an online shared content; and
the recommendation of the one discussion is displayed on a social media site.
